(19) United States
(12) Patent Application Publication
(10) Pub. No.: US 2026/0230508 A1
(43) Pub. Date: Aug. 6, 2026

(54) METHOD AND SYSTEM FOR ROUTING CLOUD TRAFFIC BETWEEN APPLICATIONS

(71) Applicant: JPMorgan Chase Bank, N.A., New York, NY (US)

(72) Inventors: Priyanka LOKHANDE, Mumbai (IN); Arsh BHARDWAJ, Mumbai (IN)

(73) Assignee: JPMorgan Chase Bank, N.A., New York, NY (US)

(21) Appl. No.: 19/462,619

(22) Filed: Jan. 28, 2026

(30) Foreign Application Priority Data
Feb. 5, 2025 (IN) 202511009443

(51) Int. Cl. H04L 9/40

(52) U.S. Cl. CPC H04L 63/20; H04L 63/029; H04L 63/08

(57) ABSTRACT

A system and method for routing cloud traffic between applications are disclosed. The method includes receiving a connection request with a connection data from an entity to establish a connection between at least one source application and at least one target application. The method further includes validating the connection data to authenticate the connection request. The method further includes establishing the connection between the at least one source application and the at least one target application based on the successful authentication of the connection request and meeting predefined criteria. The method further includes routing the cloud traffic from the at least one source application to the at least one target application.

### CROSS-REFERENCE TO RELATED APPLICATIONS

This application claims priority benefit from Indian Application No. 202511009443, filed on February 5, 2025 in the India Patent Office, which is hereby incorporated by reference in its entirety.

### BACKGROUND

### 1.Field

This technology generally relates to the fields of routing and cloud computing, and more particularly relates to a method and a system for routing cloud traffic between applications.

### 2. Background

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Organizations often face difficulties when attempting to connect public cloud computing applications with private cloud non-internet facing applications (hereinafter also referred to as non-IFA(s)). The non-IFAs within private cloud framework are applications that have no direct connection to and from the internet. Currently, the integration of public cloud computing applications with non-IFAs present within a private cloud framework face significant challenges, particularly in terms of network connectivity, connection patterns, and routing efficiency. Further, the non-IFAs require establishing a separate public cloud traffic route to facilitate such integration. This necessity complicates the architecture of on-premises systems and introduces the need of multiple routing patterns for different types of public cloud applications. It also introduces reliability issues, as the routing pattern adoption requires additional code and configuration changes for every new public cloud application that needs to connect to it. Moreover, these changes necessitate a production release to take effect.

Hence, in light of these and other existing limitations, there arises an imperative need to provide an efficient solution to overcome the above-mentioned limitations and to provide a method and a system for routing cloud traffic between the public cloud computing applications and private cloud non-internet facing applications.

### SUMMARY

The present disclosure, through one or more of its various aspects, embodiments, and/or specific features or sub-components, provides, inter alias, various systems, servers, devices, methods, media, programs, and platforms for routing cloud traffic between applications.

According to an aspect of the present disclosure, a method for routing cloud traffic between applications is disclosed. The method is implemented by at least one processor. The method includes receiving, by the at least one processor, a connection request with a connection data from an entity to establish a connection between at least one source application and at least one target application. The method further includes validating, by the at least one processor, the connection data to authenticate the connection request. The method further includes establishing, by the at least one processor, the connection between the at least one source application and the at least one target application based on a successful authentication of the connection request and meeting predefined criteria. The method further includes routing, by the at least one processor, the cloud traffic from the at least one source application to the at least one target application.

In accordance with an exemplary embodiment, the connection data may include at least one from among a request identifier (ID), a prefix, and a uniform resource locator (URL) associated with the at least one target application.

In accordance with an exemplary embodiment, the connection data may be validated using at least one validation rule.

In accordance with an exemplary embodiment, the predefined criterion may include at least one from among approved connection patterns, security policies, and a plurality of proxy rules.

In accordance with an exemplary embodiment, the approved connection patterns are predefined patterns of connections that are permitted within an on-premises system.

In accordance with an exemplary embodiment, the at least one source application may be a cloud computing application.

In accordance with an exemplary embodiment, the at least one target application may be a non-internet facing application.

In accordance with an exemplary embodiment, the connection request for connecting the at least one source application with a plurality of target applications may be executed through a firewall port by utilizing a connector service module.

According to another aspect of the present disclosure, a computing device configured for routing cloud traffic between applications is disclosed. The computing device includes a processor; a memory storing instructions; and a communication interface coupled to each of the processor and the memory. The processor may be programmed to cooperate with the instructions to perform operations including receiving a connection request with a connection data from an entity to establish a connection between at least one source application and at least one target application; validating the connection data to authenticate the connection request; establishing the connection between the at least one source application and the at least one target application based on the successful authentication of the connection request and meeting predefined criteria; and routing the cloud traffic from the at least one source application to the at least one target application.

In accordance with an exemplary embodiment, the connection data may include at least one from among a request identifier (ID), a prefix, and a uniform resource locator (URL) associated with the at least one target application.

In accordance with an exemplary embodiment, the connection data may be validated using at least one validation rule.

In accordance with an exemplary embodiment, the predefined criterion may include at least one from among approved connection patterns, security policies, and a plurality of proxy rules.

In accordance with an exemplary embodiment, the approved connection patterns are predefined patterns of connections that are permitted within an on-premises system.

In accordance with an exemplary embodiment, the at least one source application may be a cloud computing application.

In accordance with an exemplary embodiment, the at least one target application may be a non-internet facing application.

In accordance with an exemplary embodiment, the connection request to connect the at least one source application with a plurality of target applications may be executed through a firewall port by utilizing a connector service module.

According to yet another aspect of the present disclosure, a non-transitory computer-readable storage medium storing instructions for routing cloud traffic between applications is disclosed. The instructions include executable code which, when executed by a processor, may cause the processor to perform operations including receiving a connection request with a connection data from an entity to establish a connection between at least one source application and at least one target application; validating the connection data to authenticate the connection request; establishing the connection between the at least one source application and the at least one target application based on the successful authentication of the connection request and meeting predefined criteria; and routing the cloud traffic from the at least one source application to the at least one target application.

In accordance with an exemplary embodiment, the connection data may include at least one from among a request identifier (ID), a prefix, and a uniform resource locator (URL) associated with the at least one target application.

In accordance with an exemplary embodiment, the connection data may be validated using at least one validation rule.

In accordance with an exemplary embodiment, the predefined criterion may include at least one from among approved connection patterns, security policies, and a plurality of proxy rules.

In accordance with an exemplary embodiment, the approved connection patterns are predefined patterns of connections that are permitted within an on-premises system.

In accordance with an exemplary embodiment, the at least one source application may be a cloud computing application.

In accordance with an exemplary embodiment, the at least one target application may be a non-internet facing application.

In accordance with an exemplary embodiment, the connection request to connect the at least one source application with a plurality of target applications may be executed through a firewall port by utilizing a connector service module.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for routing cloud traffic between applications, in accordance with an exemplary embodiment of the present disclosure.

FIG. 2 illustrates an exemplary diagram of a network environment for routing cloud traffic between applications, in accordance with an exemplary embodiment of the present disclosure.

FIG. 3 illustrates a system diagram for routing cloud traffic between applications, in accordance with an exemplary embodiment of the present disclosure.

FIG. 4 illustrates an exemplary method flow diagram for routing cloud traffic between applications, in accordance with an exemplary embodiment of the present disclosure.

FIG. 5 illustrates a block diagram representing a system for routing cloud traffic between applications, in accordance with an exemplary embodiment of the present disclosure.

FIG. 6 illustrates a flowchart representing a process for routing cloud traffic between traffic between applications, in accordance with an exemplary embodiment of the present disclosure.

FIG. 7 illustrates an exemplary architecture depicting creation of a firewall connection request for enabling controlled routing of cloud traffic between a source application and a target on-premises application, in accordance with an exemplary embodiment of the present disclosure.

FIG. 8 illustrates an automated process for dynamically updating proxy and network authorization rules to enable secure routing of cloud traffic between a source application and a target application, in accordance with an exemplary embodiment of the present disclosure.

FIG. 9 illustrates an end-to-end request flow for securely routing an application programming interface (API) request from a source application hosted in a cloud environment to a target application hosted in an on-premises cluster, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

In today’s increasingly interconnected digital landscape, the integration of diverse application ecosystems poses significant challenges. Organizations often face difficulties when attempting to connect public cloud computing applications with private cloud non-internet-facing applications (IFA) as it requires creation of multiple routing patterns in repetitive manner to route cloud traffic between such applications. Hence, internal teams of the organization need to perform repetitive tasks of creating multiple routing patterns between the cloud computing applications and on-premises non-IFA.

To overcome the above-mentioned problems, the present disclosure provides a method and system for routing cloud traffic between applications. In the present disclosure, at first the system receives a connection request with a connection data from an entity to establish a connection between at least one source application and at least one target application. Further, the system validates the connection data to authenticate the connection request. The system further establishes the connection between the at least one source application and the at least one target application based on the successful authentication of the connection request and meeting predefined criteria. Thereafter, the system routes the cloud traffic from the at least one source application to the at least one target application.

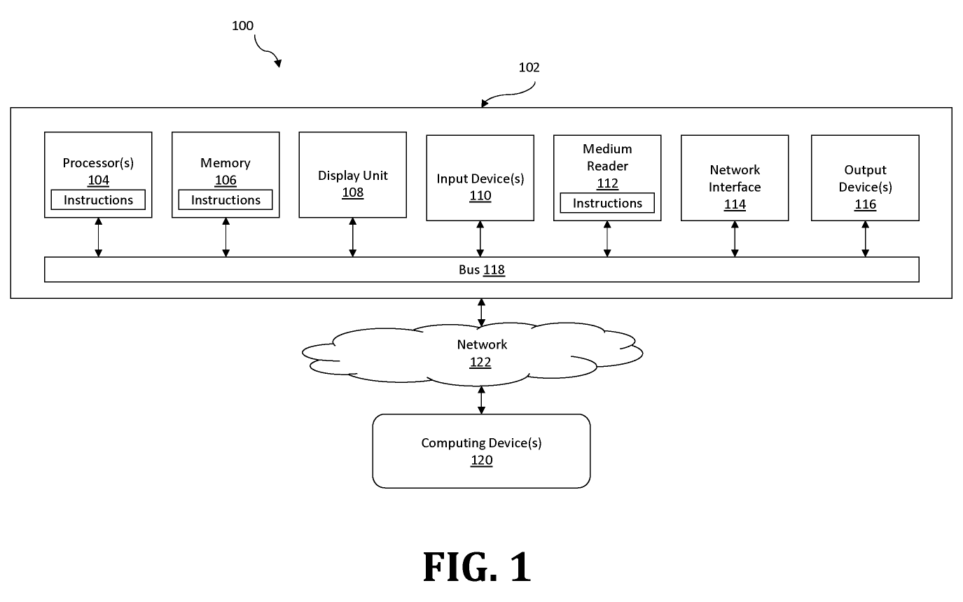

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for routing cloud traffic between applications.

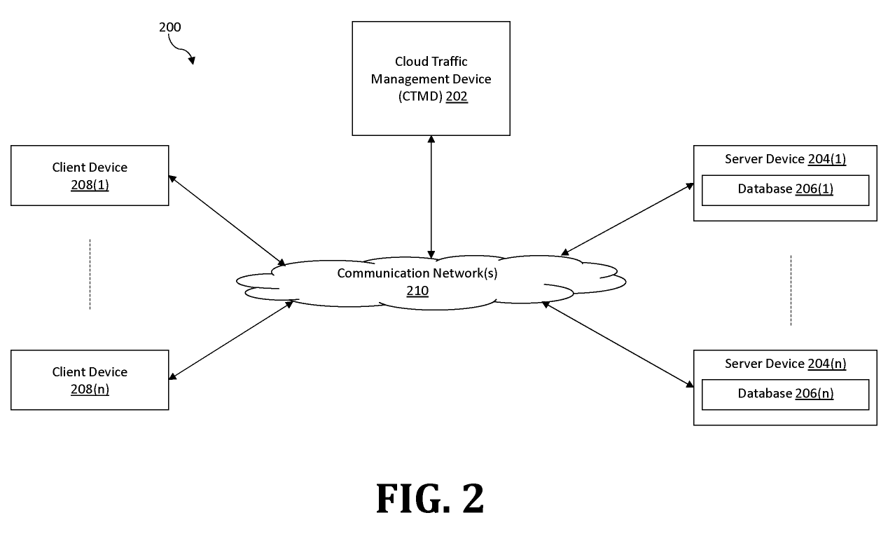

Referring to FIG. 2, a schematic of an exemplary network environment 200 for routing cloud traffic between applications is illustrated. In an exemplary implementation, the method is executable on any networked computer platform, such as, for example, a personal computer (PC).

The method for routing cloud traffic between applications may be executed by a cloud traffic management device (CTMD) 202. The CTMD 202 may be the same or similar to the computer system 102 as described with respect to FIG. 1. The CTMD 202 may store one or more applications that may include executable instructions that, when executed by the CTMD 202, cause the CTMD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the CTMD 202 itself, may be located in the virtual server(s) running in a cloud-based computing environment rather than being tied to one or more specific physical network computing devices. Also, the application(s) may be running in one or more virtual machines (VMs) executing on the CTMD 202. Additionally, in one or more embodiments of this technology, virtual machine(s) running on the CTMD 202 may be managed or supervised by a hypervisor.

In the network environment 200 of FIG. 2, the CTMD 202 is coupled to a plurality of server devices 204(1)-204(n) that host a plurality of databases 206(1)-206(n), and also to a plurality of client devices 208(1)-208(n) via communication network(s) 210. A communication interface of the CTMD 202, such as the network interface 114 of the computer system 102 of FIG. 1, operatively couples and communicates between the CTMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CTMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and CTMDs that efficiently implement the method to route cloud traffic between applications.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The CTMD 202 may be a standalone device or integrated with one or more other devices or apparatuses, such as one or more of the server devices 204(1)-204(n), for example. In one particular example, the CTMD 202 may include or be hosted by one of the server devices 204(1)-204(n), and other arrangements are also possible. Moreover, one or more of the devices of the CTMD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the CTMD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store connection requests, connection data associated with the connection requests, a plurality of proxy rules, validation rules, predefined criteria and information about applications (e.g., on-premises applications) associated with at least one cloud service platform, for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CTMD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the CTMD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the CTMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CTMD 202, the server devices 204(1)-204(n), or the client devices 208(1)-208(n), for example, may be configured to operate as virtual instances on the same physical machine. In other words, one or more of the CTMD 202, the server devices 204(1)-204(n), or the client devices 208(1)-208(n) may operate on the same physical device rather than as separate devices communicating through communication network(s) 210. Additionally, there may be more or fewer CTMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

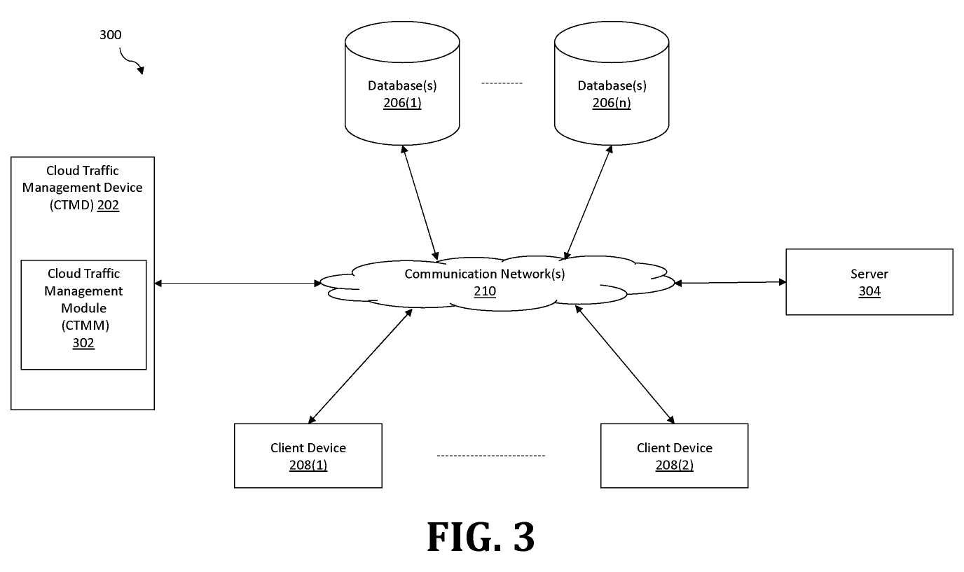

FIG. 3 illustrates a system diagram for routing cloud traffic between applications, in accordance with an exemplary embodiment.

As illustrated in FIG. 3, the system 300 may include a cloud traffic management device (CTMD) 202 within which a cloud traffic management module (CTMM) 302 is embedded, a server 304, a database(s) 206(1) … 206(n), a plurality of client devices 208(1) … 208(2), and a communication network(s) 210.

According to exemplary embodiments, the system 300 may comprise the CTMD 202 including the CTMM 302 may be connected to the server 304 and the database(s) 206(1) … 206(n) via the communication network(s) 210, but the disclosure is not limited thereto. The CTMD 202 may also be connected to the plurality of client devices 208(1) … 208(2) via the communication network(s) 210, but the disclosure is not limited thereto. The database(s) 206(1) … 206(n) may include rule database.

In an embodiment, the CTMD 202 is described and shown in FIG. 3 includes the CTMM 302, although it may include other rules, policies, modules, databases, or applications, for example. As will be described below, the CTMM 302 is configured to carry out a method for routing cloud traffic between applications.

An exemplary system 300 for enabling a mechanism for routing cloud traffic between applications by utilizing the network environment of FIG. 2 is shown as being executed in FIG. 3. Specifically, a first client device 208(1) and a second client device 208(2) are illustrated as being in communication with CTMD 202. In this regard, the first client device 208(1) and the second client device 208(2) may be “clients” of the CTMD 202 and are described herein as such. Nevertheless, it is to be known and understood that the first client device 208(1) and/or the second client device 208(2) need not necessarily be “clients” of the CTMD 202, or any entity described in association therewith herein. Any additional or alternative relationship may exist between either or both of the first client device 208(1) and the second client device 208(2) and the CTMD 202, or no relationship may exist.

Further, the CTMD 202 is illustrated as being able to access one or more database(s) 206(1) … 206(n). The CTMM 302 may be configured to access these repositories/databases to provide a method for routing cloud traffic between applications. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the CTMD 202 via broadband or cellular communication. These embodiments are merely exemplary and are not limiting or exhaustive.

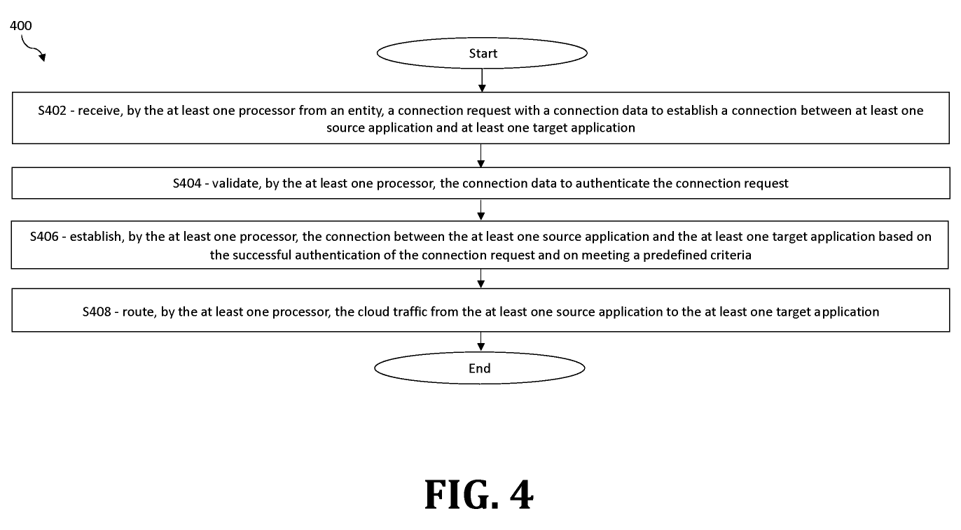

Referring to FIG. 4, an exemplary method 400 is shown for routing cloud traffic between applications, in accordance with an exemplary implementation.

The method begins when a user wants to establish a connection for routing cloud traffic from at least one application (also referred to as source application) associated with a cloud service platform to non-internet facing applications (IFAs), also referred to herein as target application, which are operated as on-premises applications within an organization. The method 400 is implemented by at least one processor 104. A user is an individual who interacts with a portal for routing cloud traffic from the at least one application (e.g., a source application) to the on-premises non-IFAs (e.g., a target application).

At step S402, the method includes receiving, by the at least one processor 104, a connection request (hereinafter also referred to as onboarding request) with a connection data from an entity to establish the connection between at least one source application and at least one target application. In one implementation, predefined criteria to establish the connection may be to get onboarded to a connector service. The connection data may include at least one from among a request ID, a prefix, and a URL associated with the at least one target application.

In an exemplary implementation, the connection data may include at least one from among a connection type, authentication tokens, and a timestamp. The connection type herein may refer to a specification of the type of connection being requested (e.g., an application programming interface (API) call, data transfer, etc.), which may help in routing the request appropriately. As used herein, entity herein may refer to an individual or a system that has its own distinct identity within a network or application environment. Specifically, the entity may be a source of the connection request, which could be a user or a network management system attempting to establish communication with the target application.

As used herein, the request identifier may refer to a distinct code or a number assigned to the connection request by the entity that ensures it can be uniquely distinguished from all other connection requests. As used herein, the term prefix may indicate the initials of the request or a specific application domain, helping to route or manage the connection request appropriately. For example, if a prefix is defined as data-publishing-hydration, then such prefix may be mapped to the at least one target application. As used herein, the URL may point to the location of the specific target application.

In an exemplary implementation, the at least one source application may be a cloud-based application. The at least one target application may be an application operating in an on-premises environment of an organization. In an exemplary implementation, the at least one source application and the at least one target application may be non-IFAs. As used herein, non-IFAs may refer to applications that are designed to operate within a controlled or private network environment, meaning thereby they are not directly accessible from the public internet.

In an example, the entity may raise the onboarding request over a portal or via a user interface (UI) associated with a connector service by a connector service module. The onboarding request may be stored in a database for determining which proxy rule(s) to apply for routing the cloud traffic from the at least one source application to the at least one target application. In one implementation, the onboarding request may be created with the portal (e.g., connection service’s portal) which dynamically updates the local proxy resources and a plurality of rules. Hence, the disclosed method is a dynamic, self-serviced and scalable solution.

At step S404, the method includes validating, by the at least one processor 104, the connection data to authenticate the connection request. The connection data may be validated using at least one validation rule.

In an exemplary implementation, once the onboarding request gets authenticated, then the at least one processor 104 may follow an automation process to update a plurality of proxy rules to establish the connection between the at least one source application and the at least one target application.

At step S406, the method includes establishing, by the at least one processor 104, the connection between the at least one source application and the at least one target application based on the successful authentication of the connection request and meeting predefined criteria. The predefined criterion may include at least one from among approved connection patterns, security policies, and the plurality of proxy rules.

The approved connection patterns may be predefined patterns of connections that are permitted within the on-premises system. Such patterns may include specific protocols, endpoints, and workflows that have been vetted for security and functionality. The security policies may refer to guidelines and rules that may dictate how any data and network traffic should be handled to maintain security. The security policies may include encryption standards and access controls. The proxy rules may define how the connection requests are managed and routed through proxy servers.

In an exemplary implementation, the connection request for connecting the at least one source application with a plurality of target applications may be executed through a firewall port by utilizing a connector service module. For example, if the at least one source application wishes to connect to multiple target applications, then a firewall port opening request may be created for only one connector service instead of multiple target applications. It is to be noted that the target application does not have to do any code or make configuration changes for every new source application that wants to connect to it.

At step S408, the method includes routing, by the at least one processor 104, the cloud traffic from the at least one source application to the at least one target application using the plurality of proxy rules that were defined at the time of onboarding.

As used herein, the cloud traffic may refer to the data transferred between the at least one source application and the at least one target application over the Internet or a private network. The cloud traffic may include various types of data and interactions, depending on the services being utilized.

This way the method disclosed in the present disclosure provides an efficient routing of the cloud traffic data between the at least one source application and the at least one target application.

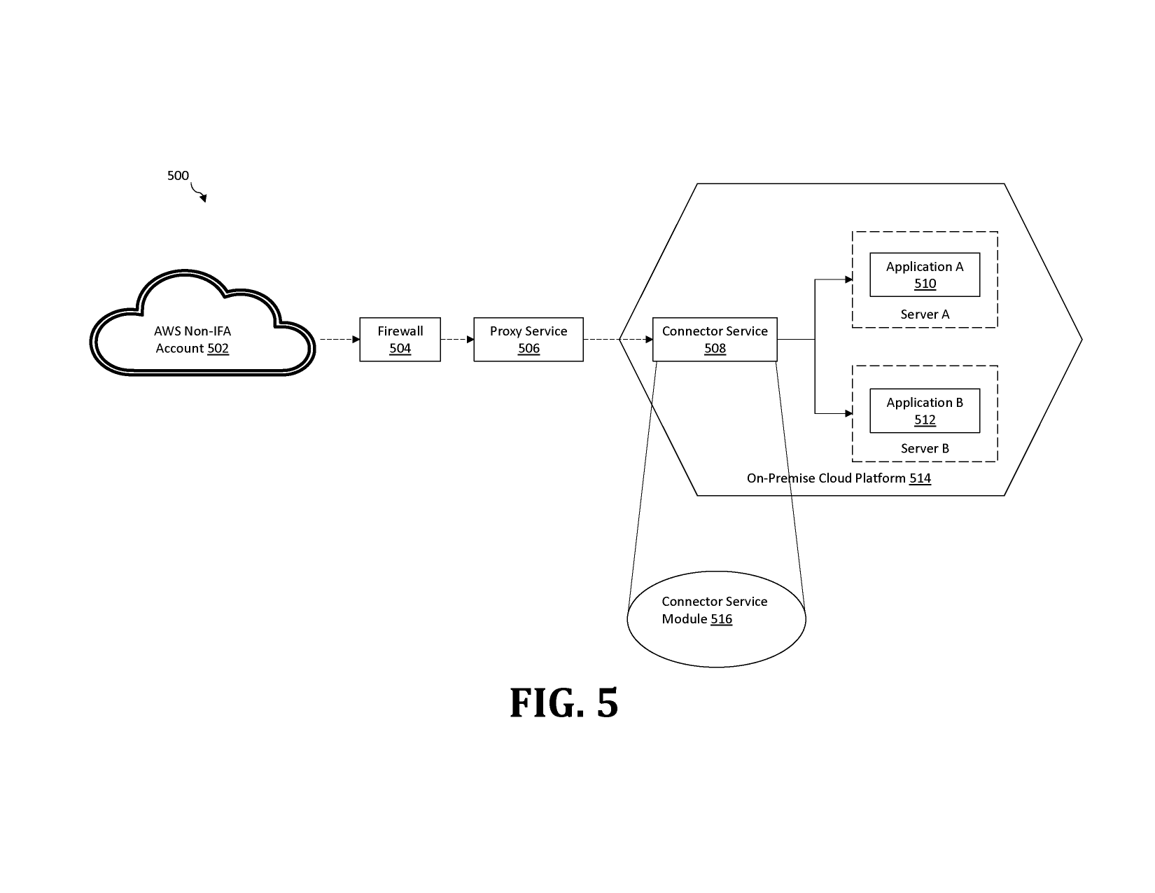

FIG. 5 illustrates a block diagram that represents a system for routing a cloud traffic between applications, in accordance with an exemplary embodiment. As illustrated in FIG. 5, the process flow 500 begins with receiving, by at least one processor 104, a connection request (e.g., firewall connection request) through a non-IFA account 502 associated with a cloud computing platform (e.g., amazon web service (AWS^{®})). The connection request (hereinafter also referred to as onboarding request) is provided with a connection data by an entity to establish a connection between at least one source application (e.g., non-IFA AWS^{®} application) and at least one target application (e.g., on-premises non-IFAs). As used herein, “entity” refers to an individual or system that has its own distinct identity within a network or application environment. Specifically, the entity may be a source of the connection request, which may be a user or a network management system attempting to establish communication with another application (e.g., a target application) using a portal or the non-IFA account 502. In an example, the entity may raise the onboarding request over a portal, or a user interface (UI) of a connector service module 516 associated with the connector service 508.

In an exemplary implementation, the predefined criterion for the connection to be successful may be that the at least one source application is correctly onboarded to a connector service 508 by a connector service module 516. The connection data may include a request identifier (ID), a prefix, and a URL associated with the at least one target application. In yet another exemplary implementation, the onboarding request may include a title and a description of the connection. For example, if a prefix is defined as data-publishing-hydration, then such prefix is mapped to the at least one target application. In an exemplary implementation, the onboarding request may be created with a portal (e.g., UI of the connector service module 516) which dynamically updates the local proxy resources and a plurality of rules. This way, the disclosed method provides a dynamic, self-serviced and a scalable solution. In an exemplary implementation, the connection request or the onboarding request to connect the at least one source application with a plurality of target applications may be executed through a firewall port by utilizing the connector service module 516. For example, if the at least one source application wishes to connect to multiple target applications, then the at least one processor 104 may create a firewall port opening request for only one connector service 508 instead of multiple target applications. It is to be noted that the target application does not have to perform any code or configuration changes for every new source application that wants to connect to it.

In an exemplary implementation, once the onboarding request is authenticated, then at least one processor 104 may follow an automation process to update the plurality of proxy rules to establish the connection between the at least one source application and the at least one target application. The firewall opening request may be raised by the entity to open ports of firewall 504 present between the cloud computing platform and on-premises cloud computing platform 514. It is to be noted that the application owner of the source application may need to approve such a request to establish connection between the at least one source application and a proxy service 506. This connection request ID may be used to onboard the at least one source application to the connector service 508. Further, the at least one source application 504 may send the connection request to the proxy service 506. Further, the proxy service 506 may forward the request to the connector service 508. Further, the connector service 508 may take the connection request from the proxy server 506 and validate it for routing. The connector service 508 may establish the connection between the at least one source application and the at least one target application based on the successful authentication of the connection request and upon meeting predefined criteria. The predefined criterion may include at least one from among approved connection patterns, security policies, and a plurality of proxy rules. The connector service 508 may further route cloud traffic coming from the at least one source application to the at least one target application using a predefined local resource and plurality of its rules. The predefined local resource may refer to a dedicated networking infrastructure such as but not limited to a virtual private cloud (VPC) subnet, an internal routing gateway, or a secured service mesh for providing controlled and efficient traffic flow. The plurality of rules associated with the predefined local resource may include but not limited to a set of network segmentation policies, a firewall access control lists (ACLs), a set of traffic load balancing rules, and role-based access control (RBAC) policies that govern and regulate the secure transmission of data between applications.

For example, a non-IFA account 502 (such as AWS^{®} application) may be connected with two on-premises applications (such as application A 510 which corresponds to server A and application B 512 which corresponds to server B) by the connector service 508 using the predefined local proxy resource and the plurality of its rules.

In an exemplary implementation, the connector service 508 may be managed through a user interface (UI) of the portal. The portal or a dashboard may include a plurality of options such as, but not limited to, route management, observability, connection requests and their status, and configured application programming interface (APIs). Hence, the portal may allow the entity to monitor connection requests and perform routing management. This way the system 500 routes the cloud traffic between applications.

It will be appreciated by the person skilled in the art that the system offers a full-circle, adaptable, and intelligent solution for implementing a method to route cloud traffic between applications.

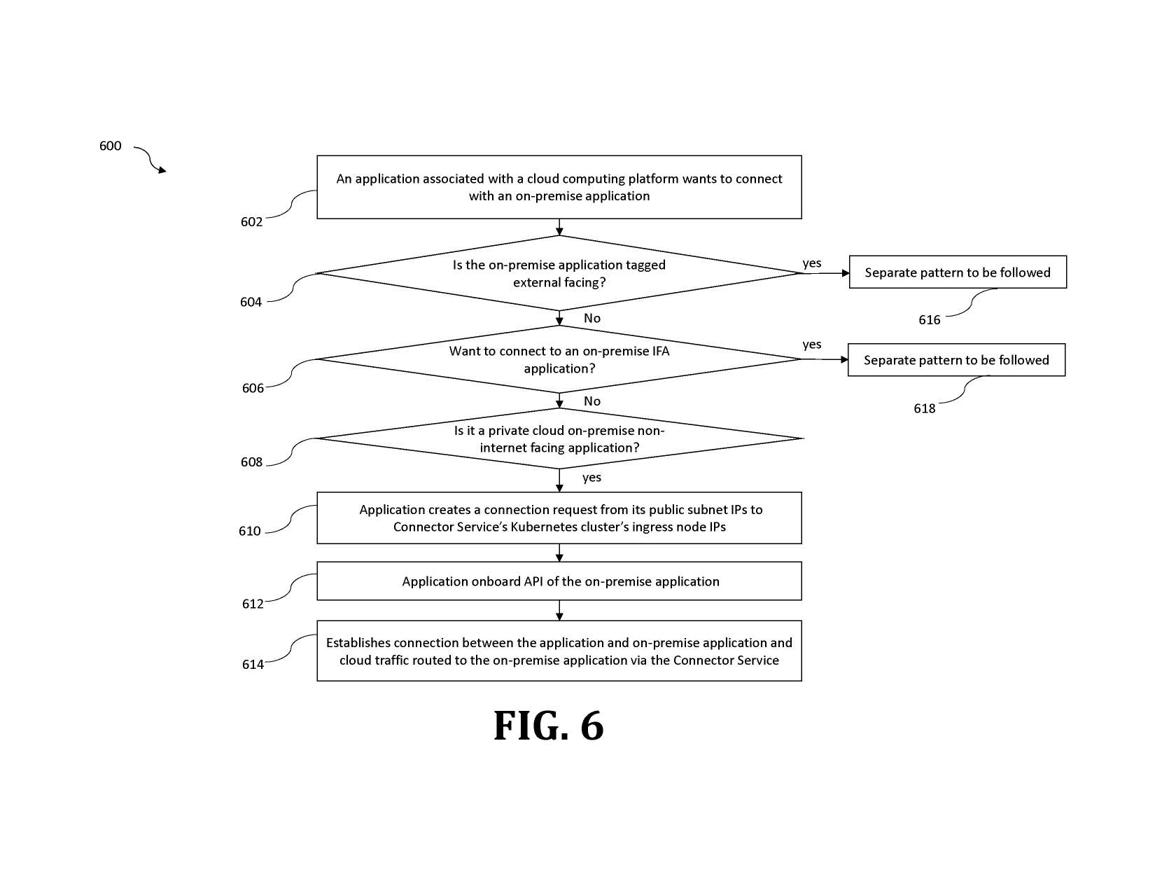

FIG. 6 illustrates a flowchart representing a process for routing cloud traffic between applications, in accordance with an exemplary embodiment of the present disclosure. As illustrated in FIG. 6, the process flow 600 begins at step 602 wherein an application associated with a cloud computing platform wants to connect with an on-premises application within an on-premises cloud platform. At step 604, the process includes determining whether the application tagged is external facing or not. In case the application tagged is external facing application then the process moves to step 616 where a separate pattern needs to be followed for such external facing applications. In case the application tagged is not an external facing application then the process moves to step 606 to further determine whether the application wants to connect to an on-premises non-internet facing application. If the application wants to connect with the internet-facing application (IFA) then the process moves to step 618 wherein a separate pattern needs to be followed for making the connection with the IFA. In case the application wants to connect to non-IFA then the process moves to step 608. At step 608, the process continues to check whether the on-premises non-IFA is an internal application platform. In an exemplary implementation, the internal application platform may include private cloud on-premises non-internet facing applications. In case the application is a non-IFA application, then the process moves to step 610.

At step 610, a source application creates a connection request from its public subnet internet protocols (IPs) to the Connector Service’s Kubernetes cluster’s ingress node IPs corresponding to a proxy service. At step 612, the application onboards an API of the on-premises application through the UI of the connector service module. The onboarding process may involve providing necessary API onboarding details to enable seamless integration with the on-premises application. After receiving a connection request from the source application, at step 614, the connector service module establishes a connection between the source application and the on-premises application and routes the cloud traffic from the source application to the on-premises application (or target application). Thereafter, the process flow 600 ends.

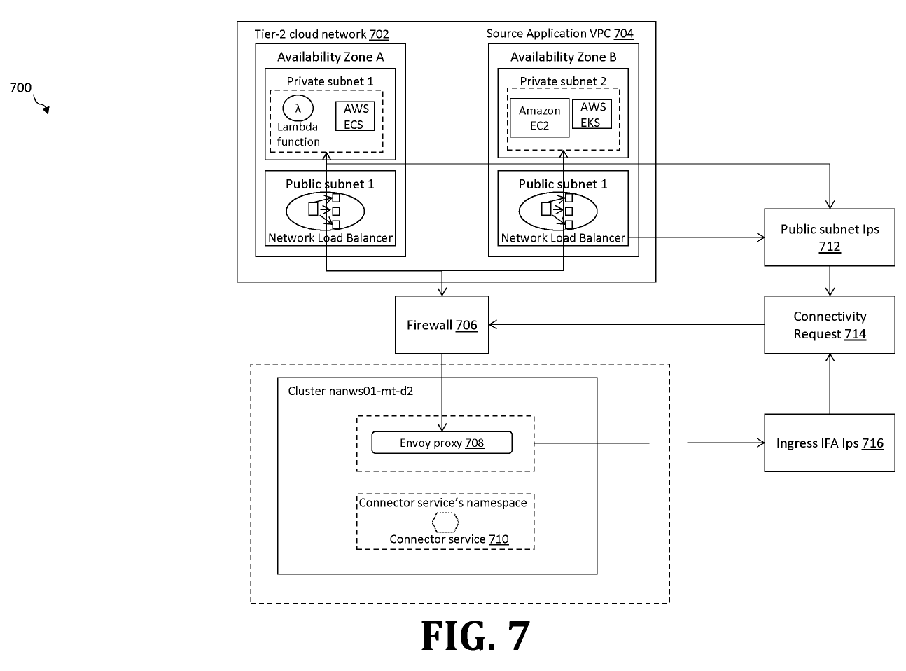

FIG. 7 illustrates an exemplary architecture 700 depicting creation of a firewall connection request for enabling controlled routing of cloud traffic between a source application and a target on-premises application, in accordance with an exemplary embodiment of the present disclosure.

As shown in FIG. 7, a source application executes within a Tier-2 cloud network 702 and a Source Application Virtual Private Cloud (VPC) 704, each comprising multiple availability zones, such as availability zone A and availability zone B. The availability zone A may include a private subnet 1 hosting compute resources such as a Lambda function and AWS ECS containers, and a public subnet 1 hosting a Network Load Balancer (NLB). Similarly, the availability zone B may include a private subnet hosting Amazon EC2 instances and AWS EKS pods, and a public subnet 1 hosting a corresponding NLB. The public subnets in the respective availability zones may expose externally reachable IP addresses that are retrieved as part of the firewall connection request creation pipeline.

The public subnet Ips 712 may be collected from the NLBs operating in each availability zone. The public subnet IPs 712 may identify the outbound network interfaces through which a source application initiates connections toward target environment. The collected public subnet IPs may be forwarded to a firewall connection request generator (not shown) which compiles relevant connection parameters into a structured firewall connection request 714. The firewall connection request 714 may include, for example, the source application details, the public subnet IPs, and additional routing information that may be required to authenticate and authorize the connection at the destination.

As further shown, an on-premises cluster, illustrated as Cluster nanws01-mt-d2, may be connected to the cloud network via a firewall 706. Within this cluster, an Envoy proxy 708 may operate as an enforcement and policy-validation layer. The Envoy proxy 708 may receive ingress IFA (Ingress Front-End Address) IPs 716, which represent the reachable front-end network addresses within the on-premises environment. These ingress IPs 716 may be incorporated into the firewall connection request 714, enabling the source application to identify the appropriate forwarding endpoints for traffic destined for the target application.

In the same cluster, a connector service 710 may execute within its dedicated namespace. The connector service 710 may be configured to receive onboarding request that may include firewall request identifier generated by a connectivity manager. The connector service 710 may interact with the Envoy proxy 708 to validate the firewall connection request 714, confirm the authenticity of the source application’s public IPs, and ensure the target application is reachable through the defined IFA endpoints.

Following validation by the Envoy proxy 708, updated routing configurations and network policies may be enabled within the on-premises cluster, thereby allowing the source application operating within the AWS environment 702, 704 to securely route cloud traffic toward the target application through the connector service 710 and Envoy proxy 708.

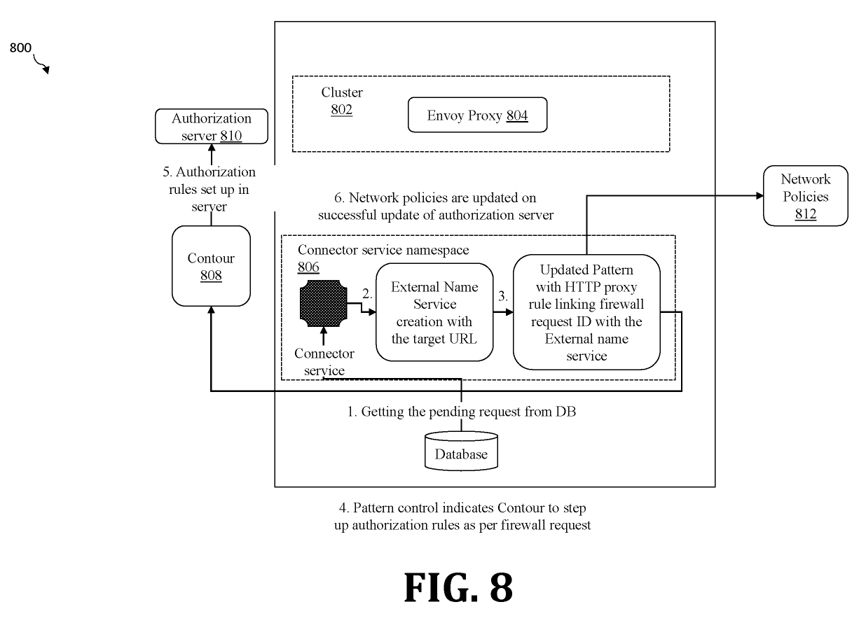

FIG. 8 illustrates an automated process 800 for dynamically updating proxy and network authorization rules to enable secure routing of cloud traffic between a source application and a target application, in accordance with an exemplary embodiment of the present disclosure.

As shown in FIG. 8, the automation is executed within a cluster 802 hosting an envoy proxy 804 and a connector service deployed within a connector service namespace 806. The process 800 begins when a connector service retrieves a plurality of pending onboarding requests from a database, as indicated in step 1. Each pending request may include a firewall or a connectivity manager request identifier, a prefix associated with a target application, and a target application uniform resource locator (URL) or fully qualified domain name.

Upon retrieving a pending request, the connector service may initiate creation of an external name service corresponding to the target application URL, as shown in step 2. The external name service may enable name-based forwarding of requests from the envoy proxy 804 to the target application without exposing the target application directly to a source network.

At step 3, the connector service may update an approved pattern or proxy configuration by associating the firewall and the provided prefix with the newly created external name service. This association may define routing conditions under which traffic matching the prefix and validated request identifier is forwarded to the target application.

Thereafter, a pattern controller may signal a proxy configuration component (for example, a Contour 808) to establish or update authorization rules based on the firewall or connectivity manager request details, as illustrated in step 4. These authorization rules may be propagated to an authorization server 810, which validate the routing intent and applies access control policies corresponding to the source and target application parameters, as shown in step 5.

Following successful configuration of authorization rules, network policies 812 associated with the envoy proxy 804 may bee updated, as indicated at step 6. These updated network policies 812 may ensure that only traffic satisfying the validated firewall or connectivity manager request identifier, source application parameters, and prefix-based routing rules is permitted to traverse the envoy proxy 804.

Once the proxy rules and network policies are successfully updated, the envoy proxy 804 may enforce new configuration, enabling automated, secure, and dynamic routing of cloud traffic from the source application to the target application via the connector service. This automation may eliminate the need for manual proxy rule updates and reduces dependency on manual intervention by on-premises network administrators.

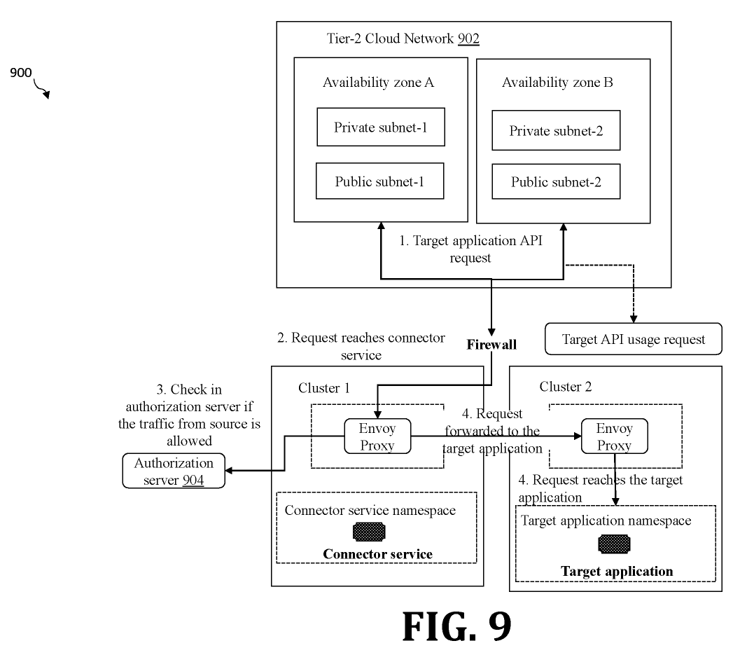

FIG. 9 illustrates an end-to-end request flow 900 for securely routing an application programming interface (API) request from a source application hosted in a cloud environment to a target application hosted in an on-premises cluster, in accordance with an exemplary embodiment of the present disclosure.

As shown in FIG. 9, the source application may be deployed within a Tier-2 cloud network 902 (such as an AWS Virtual Private Cloud (VPC)), spanning multiple availability zones (for example, Availability Zone A and Availability Zone B). Each availability zone may include private subnets hosting compute workloads, such as serverless functions, container services, virtual machines, or orchestration platforms, and public subnets hosting network load balancers. The load balancers may provide ingress points for outbound API requests originating from the source application.

In operation, the source application may initiate a target application API request, as indicated in step 1. The target application API request may include a connector service URL, a predefined prefix, and a target API URL path. The request may be routed through the Tier-2 cloud network 902 and traverses a firewall boundary separating the Tier-2 cloud network 902 from an on-premises environment.

At step 2, the target application API request may reach a connector service deployed within a first on-premises cluster (for example, Cluster 1) operating in a Tier-3 on-premises environment. The connector service may be exposed via an Envoy proxy, which acts as a policy enforcement and routing component for incoming traffic.

Before forwarding the target application API request, the envoy proxy may perform an authorization check by communicating with an authorization server 904, as shown in step 3. The authorization server 904 may evaluate whether traffic from the source application is permitted based on predefined authorization rules, firewall or connectivity management request identifiers, prefix-based routing rules, and associated access control policies.

Upon successful authorization, the envoy proxy may forward the target application API request toward the target application, as indicated in step 4. In the exemplary implementation, the target application API request may be routed from the first on-premises cluster (Cluster 1) to a second on-premises cluster (for example, Cluster 2), where the target application is deployed within a dedicated target application namespace. A corresponding envoy proxy in the target Cluster 2 may receive the forwarded request and delivers it to the target application instance.

As a result, the target application may receive the API request originating from the source application in the Tier-2 cloud network 902 in a secure and controlled manner. The depicted flow may ensure that all traffic traversing from the source application to the target application is subject to centralized authorization validation, prefix-based routing enforcement, and proxy-mediated forwarding, thereby preventing unauthorized access and eliminating the need for direct network exposure between the Tier-2 cloud network 902 and on-premises clusters (cluster 1 and cluster 2).

The present disclosure provides several advantages as given below. The disclosed method enables seamless integration between public cloud computing applications and private cloud non-IFAs without requiring complex network configurations or modifications to the target application. By automating the connection process, the present disclosure eliminates the need for separate routing patterns, thereby reducing architectural complexities and minimizing dependency on on-premises teams. The present disclosure significantly enhances routing efficiency by utilizing a predefined connector service module, which simplifies network connectivity. Furthermore, the present disclosure eliminates the need for production releases or code changes for every new cloud-based application that needs to connect with a non-IFA, thereby accelerating the deployment process. The disclosed method also reduces operational overhead for internal teams by streamlining cloud traffic routing through an optimized network layer, which is inherently more scalable and faster than traditional application-layer-based routing. Additionally, the present disclosure provides a standardized, secure, and scalable approach to integrating cloud-based applications with non-IFAs, ensuring reliability and reducing the risk of misconfigurations. The present disclosure enhances the overall efficiency of cloud migration strategies, allowing organizations to onboard and deploy public cloud applications more quickly while maintaining robust security and operational compliance.

In addition, the disclosed method automates the otherwise manual and error-prone process of establishing secure connectivity between cloud-hosted applications and on-premises systems by dynamically generating and validating connection mappings through an Approved Network Pattern (ANP) mechanism. By leveraging automated onboarding workflows, ExternalName service creation, prefix-based routing, and Envoy-driven policy validation, the present disclosure ensures that only authenticated and authorized traffic flows between source and target applications. The approach further eliminates the need for opening static firewall ports or maintaining fixed proxy rules, thereby reducing the operational overhead associated with cross-environment communication. In addition, the use of a centralized connector service with scheduled processing and controlled updates to network policies enhances scalability, consistency, and auditability of routing decisions. Overall, the disclosed solution improves network security posture, accelerates application integration, and enables seamless hybrid-cloud interoperability with minimal administrative effort.

Although the invention has been described with reference to several exemplary embodiments, it is understood that the words that have been used are words of description and illustration, rather than words of limitation. The changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to route cloud traffic between applications is disclosed. The instructions include executable code which, when executed by a processor 104, may cause the processor 104 to receive a connection request with a connection data from an entity to establish a connection between at least one source application and at least one target application; validate the connection data to authenticate the connection request; establish the connection between the at least one source application and the at least one target application based on the successful authentication of the connection request and meeting predefined criteria; and route the cloud traffic from the at least one source application to the at least one target application.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for routing cloud traffic between applications, the method being implemented by at least one processor, the method comprising:
receiving, by the at least one processor from an entity, a connection request and connection data to establish a connection between at least one source application and at least one target application;
validating, by the at least one processor, the connection data to authenticate the connection request;
establishing, by the at least one processor, the connection between the at least one source application and the at least one target application, upon successfully authenticating that the connection request meets a predefined criterion; and
routing, by the at least one processor, the cloud traffic from the at least one source application to the at least one target application.

2. The method of claim 1, wherein the connection data comprises at least one from among a request identifier (ID), a prefix, and a uniform resource locator (URL) associated with the at least one target application.

3. The method of claim 1, wherein the connection data is validated using at least one validation rule.

4. The method of claim 1, wherein the predefined criterion comprises at least one from among approved connection patterns, security policies, and a plurality of proxy rules.

5. The method of claim 4, wherein the approved connection patterns comprise predefined patterns of connections that are permitted within an on-premises system.

6. The method of claim 1, wherein the at least one source application is a cloud computing application, wherein the at least one target application is a non-internet facing application.

7. The method of claim 1, wherein the connection request for connecting the at least one source application with a plurality of target applications, is executed through a firewall port by utilizing a connector service module.

8. A computing device configured to route cloud traffic between applications, the computing device comprising:
a processor;
a memory storing instructions; and
a communication interface coupled to the processor and the memory, wherein the processor is programmed to execute the instructions to perform operations comprising:
receiving, from an entity, a connection request and connection data to establish a connection between at least one source application and at least one target application;
validating the connection data to authenticate the connection request;
establishing the connection between the at least one source application and the at least one target application, upon successfully authenticating that the connection request meets a predefined criterion; and
routing the cloud traffic from the at least one source application to the at least one target application.

9. The computing device of claim 8, wherein the connection data comprises at least one from among a request identifier (ID), a prefix, and a uniform resource locator (URL) associated with the at least one target application.

10. The computing device of claim 8, wherein the connection data is validated using at least one validation rule.

11. The computing device of claim 8, wherein the predefined criterion comprises at least one from among approved connection patterns, security policies, and a plurality of proxy rules.

12. The computing device of claim 11, wherein the approved connection patterns comprise predefined patterns of connections that are permitted within an on-premises system.

13. The computing device of claim 8, wherein the at least one source application is a cloud computing application, wherein the at least one target application is a non-internet facing application.

14. The computing device of claim 8, wherein the connection request to connect the at least one source application with a plurality of target applications, is executed through a firewall port by utilizing a connector service module.

15. A non-transitory computer readable storage medium storing instructions for routing cloud traffic between applications, the instructions comprising executable code which, when executed by a processor, cause the processor to perform operations comprising:
receiving, from an entity, a connection request and connection data to establish a connection between at least one source application and at least one target application;
validating the connection data to authenticate the connection request;
establishing the connection between the at least one source application and the at least one target application, upon successfully authenticating that the connection request meets a predefined criterion; and
routing the cloud traffic from the at least one source application to the at least one target application.

16. The non-transitory computer readable storage medium of claim 15, wherein the connection data comprises at least one from among a request identifier (ID), a prefix, and a uniform resource locator (URL) associated with the at least one target application.

17. The non-transitory computer readable storage medium of claim 15, wherein the connection data is validated using at least one validation rule.

18. The non-transitory computer readable storage medium of claim 15, wherein the predefined criterion comprises at least one from among approved connection patterns, security policies, and a plurality of proxy rules.

19. The non-transitory computer readable storage medium of claim 15, wherein the at least one source application is a cloud computing application, wherein the at least one target application is a non-internet facing application.

20. The non-transitory computer readable storage medium of claim 15, wherein the connection request for connecting the at least one source application with a plurality of target applications, is executed through a firewall port by utilizing a connector service module.
